(19) United States
(12) Patent Application Publication
(10) Pub. No.: US 2017/0158037 A1
(43) Pub. Date: Jun. 8, 2017

(54) GLAZED ROOF WITH A MOBILE PANEL CONTROLLED BY SHUTTLES

(71) Applicant: ADVANCED COMFORT SYSTEMS FRANCE SAS - ACS FRANCE, Bressuire (FR)

(72) Inventor: Mickaël DESBOIS, Bressuire (FR)

(21) Appl. No.: 15/325,500

(22) PCT Filed: Jul. 15, 2015
(86) PCT No.: PCT/EP2015/066191

§ 371 Date: Jan. 11, 2017

(30) Foreign Application Priority Data
Jul. 15, 2014 (FR) 1456801

(51) Int. Cl. B60J 7/05; B60J 7/06; B60J 7/057

(52) U.S. Cl. CPC B60J 7/05; B60J 7/057; B60J 7/06

(57) ABSTRACT

A glazed roof for a motor vehicle comprises a fixed part with an aperture and a panel that is movable relative to the fixed part, capable of closing off said aperture, the moving of said panel implementing two shuttles (11, 21) guided in translation respectively in two rails (12), means for fixed attachment/detachment to link or not link the movement of each of said shuttle with the movement of a driving cable (15). Said means of fixed attachment/detachment comprise a hooking element movable between a position of fixed attachment in which it forms an angle of 5° to 15° with the direction of said driving cable, an end portion of said hooking element cooperating with a complementary housing in said shuttle; and a detached position in which it extends appreciably in parallel to the direction of said driving cable, said end portion being moved out of said housing.

### 1. FIELD OF THE INVENTION

The field of the invention is that of glazed bays or openings for automobile vehicles or motor vehicles and more specifically for the roofs of such vehicles.

More specifically, the invention relates to glazed roofs comprising at least one aperture cooperating with a sliding movable glazed panel, and especially to devices known as “flush bays” or “flush sliding roofs” or “sunroofs” designed to be mounted so as to be flush (or almost flush) with the bodywork.

Within the framework of the present patent application, the term “glazed panel” is understood to mean any panel, fixed or movable relative to the bodywork, that is substantially transparent or translucent participating in the bay space. Such a panel can be made out of glass or any other suitable material such as a polycarbonate.

In certain embodiments, the panel can be constituted by several elements that are flush with one another when seen from the exterior. If necessary, at least one of these elements can be entirely or partly opaque and for example made out of metal or plastic. Besides, the edges of a glazed panel can be made opaque, for example by screen printing.

### 2. PRIOR ART

It is presently being sought, in the field of motor vehicles, to propose increasing amounts of glazed surfaces. In particular, manufacturers are regularly proposing vehicles that have a roof equipped with one or more glazed elements. In certain cases, the roof is entirely made out of glass or a similar material that allows light, and especially sunlight, to pass through.

Solutions have also been proposed to open one or more apertures in such a roof, especially to form a sliding roof or sunroof

The Applicant has especially proposed several solutions to control the motions of a movable panel of a flush bay or a flush sliding roof. These motions are generally complex since the opening of the movable panel requires first of all a cleared space in relation to the aperture made in the fixed part of the roof, then a sliding above or beneath the fixed part.

It can also be planned that the movable panel will be a tilting panel, i.e. that it will swivel relative to one of its edges, generally the edge oriented towards the front of the vehicle. It can also be necessary, in certain embodiments, to control the movement of other elements, such as a deflector or baffle, that guides the air above the aperture when the movable panel takes an open position.

The Applicant has proposed an efficient solution enabling the conversion of a simple, one-way actuating motion along for example a curve, defined for example by the roof. To this end, the invention implements shuttles guided in translation along the two rails and capable of being fixedly joined to cables, for example of the push/pull type.

These shuttles generally control a complex kinematic arrangement, especially using the apertures or grooves that guide pins or tie-rods acting directly or indirectly on the movable panel and if necessary on another movable element. These shuttles are for example used to obtain the clearing of the part pointed towards the front of the movable panel and/or its tilting.

It can also be necessary, in certain of these motions, to detach the shuttles from the cables so that, as the case may be, the push/pull cable continues its movement in driving other elements to which it is fixedly attached, the shuttles remaining immobile. Conversely, it can also be necessary to enable the shuttle elements to continue their movement in being driven for example by the movement of the movable panel, while the push/pull cable remains fixed. It is therefore necessary to provide for means for the fixed attachment/detachment of the shuttles, for example means that take the form of a hook or a connection element.

The different elements used to control the different motions of the movable panel are complex and must be assembled with precision. It is therefore desirable to propose simple, efficient and reliable solutions. It is furthermore desirable that these different means should be compact since the available space is very limited, and that they should be light.

### 3. SUMMARY OF THE INVENTION

The invention is aimed especially at providing a simple and efficient solution to the fixed attachment and detachment of a shuttle with its cable. These goals as well as others that shall appear more specifically here below are achieved by means of a glazed roof for a motor vehicle comprising a fixed part in which an aperture is made and a panel that is movable relative to the fixed part, capable of closing off said aperture in a closing-off position, the moving of said movable panel implementing two shuttles guided in translation respectively in two rails, means for fixed attachment/detachment making it possible to link or not link the movement of each of said shuttles with the movement of a driving cable.

According to the invention, said means of fixed attachment/detachment comprise a hooking element movable between two positions:
a position of fixed attachment in which it forms an angle of 5° to 15° with the direction of said driving cable, an end portion of said hooking element cooperating with a complementary housing in said shuttle;
a disengaged position in which it extends appreciably in parallel to the direction of said driving cable, said end portion being moved out of said housing.

Thus, the fixed attachment is obtained by making the hooking element pass from a position in which it is parallel or practically parallel to the cable and can be moved in the same channel as the cable. In the fixed attachment position, this hooking element, forming a bolt or latch, is moved angularly relative to the axis of cable so that its end cooperates with the shuttle element, more specifically a housing forming a striker, and so that this shuttle element and the cable are driven at the same time.

This angular movement can be obtained by pull-back means taking the hooking element into the fixedly attached position in the absence of stresses or by means of a fixed ramp that gradually guides the bolt-forming end portion towards the striker-forming housing.

In a first particular embodiment, said fixed attachment/detachment means can therefore include a hook over-molded on the free end of said driving cable, capable of cooperating with a complementary hooking element provided on said shuttle element in said first area of movement.

There is thus a system available that is simple to manufacture and implement, compact, low-cost and very efficient.

According to one particular embodiment, said hook can take two positions, a deployed position in which it is situated in said first movement area and a folded position in which it is situated in said second movement area.

In particular, said hook can be shaped so as to be brought back into said deployed position and/or fitted out with pull-back means tending to bring it back into said deployed position.

According to one particular embodiment, said cable circulates in a sheath or a guide housing fixedly attached to said rail.

In this case, said sheath or said housing can have a portion that is open in said first moving area and a portion that is closed is said second moving area, constraining said hook to take said folded position.

According to one particular embodiment, said hook presents a contact area cooperating with the end of said sheath or said housing to control the movement of said hook between the two positions.

This enables more efficient control of the changing of the positions of the hook.

According to one particular embodiment, said hook has two hinged elements, a first movable element to ensure fixed attachment with the shuttle and a second element remaining in the extension of said cable.

Said first element can carry a locking pin cooperating with a notch formed in the shuttle.

According to a second embodiment, said hooking element has a bolt mounted in the extension of said cable and guided between said fixed attachment position and said detachment position by a guiding ramp fixedly attached to said fixed part.

In this case, said bolt can be over-molded on the end of said cable and on an arm that is movable relative to said cable and mounted in the extension of said cable.

Said bolt can especially cooperate with a recess formed in said shuttle element.

A linking sheath can fixedly attach the free end of the cable and one end of the arm.

According to one particular embodiment, said arm can be made out of a flexible material.

According to another particular embodiment, said arm comprises a strip that is hinged relative to said cable.

According to another embodiment, said arm can be mounted so as to be rotationally movable relative to the linking part fixedly attached to said cable and/or a sheath that bears it.

### 4. DESCRIPTION OF THE FIGURES

Other characteristics and advantages of the invention shall appear from the following description of a particular embodiment of the invention, given by way of simple, illustratory and non-exhaustive examples, illustrated by the appended drawings of which:

FIGS. 1 to 3 illustrate a first embodiment of the means of fixed attachment/detachment implementing a hinged hook:

FIG. 1: a simplified view in section of the shuttle fixedly attached to the driving cable by means of the hook;

FIG. 2: a simplified view in section of the shuttle of FIG. 1 moved rightwards right and still fixedly attached to the driving cable;

FIG. 3: a simplified view in section of the shuttle of FIGS. 1 and 2, detached from the driving cable, the hook being folded;

FIGS. 4 to 8 illustrate a second embodiment of the fixed attachment/detachment means implementing a connection member constituted by an arm and a bolt:

FIG. 4: is a 3D wire frame view of the shuttle fixedly attached to the driving cable by means of the bolt;

FIG. 5: is a view in section of the connection member cooperating with a guiding ramp of a fixed part of the vehicle;

FIG. 6: is a 3D view of the connection member of FIGS. 4 and 5;

FIG. 7: shows a first alternative embodiment of the connection member;

FIG. 8: is a second alternative variant of the connection member.

### 5. DESCRIPTION OF THE INVENTION

### 5.1 First Embodiment

The invention therefore relates to a glazed roof of a vehicle and more specifically to the moving of this glazed roof.

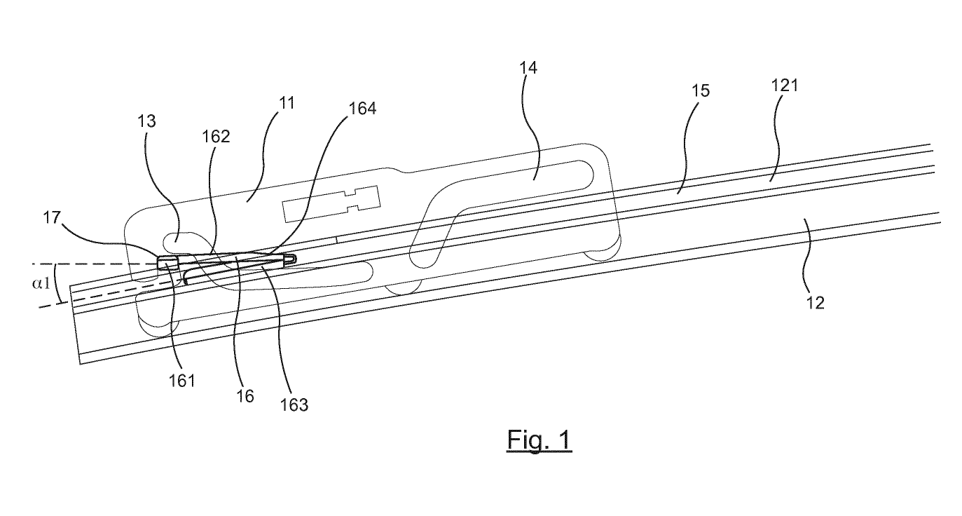

As illustrated by the three simplified views in section of FIGS. 1 to 3, the movable panel of the sliding roof is driven in movement by a shuttle 11 guided in a rail 12. Generally, two shuttles and two symmetrical rails are placed on each side of the vehicle to control the movements of the movable panel.

The shuttle 11, in this first embodiment, has two openings 13 and 14 each capable of receiving for example a movable toe or skid associated with an element controlling the moving of the movable panel, for example in the form of a tie-rod. These elements are not described here in detail since these aspects can vary according to the implementation and since particular solutions are known.

The movement of the shuttle 11 relative to the rail 12 is controlled, at least partly, by the movement of a push/pull type drive cable 15 guided in a portion 121 of the rail 12. The moving of the cable 15 can be done manually and/or it can be motor driven.

The end of the drive cable 15 carries a hooking element, in this case a hook 16, the free end of which has a bolt-forming hooking element 161, designed to cooperate with a notch 17 or a housing provided for this purpose in the shuttle 11 and forming a strike plate. The terms “bolt” and “strike plate” do not refer here to a function of a locking the sliding roof but to the respective functions of the two male and female elements designed to get joined together to fixedly attach the shuttle element and the cable and to get disconnected from each other in order to detach them.

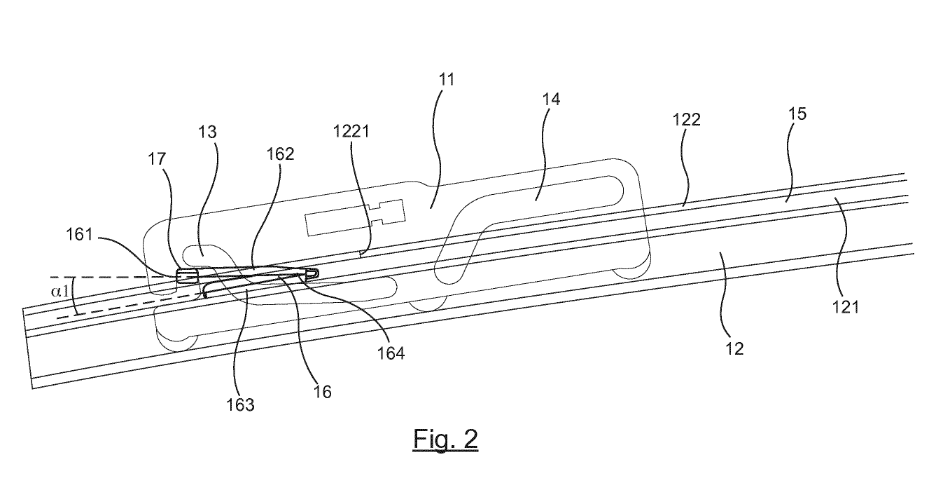

Thus, in the position illustrated by FIGS. 1 and 2, which illustrate a first movement area, the hook 16 is engaged with the shuttle 11 and the movement of the cable 15 in the sheath 121 is linked to the movement of the shuttle 11 relative to the rail 12.

According to the invention, the hook 16 is over-molded on the end of the cable 15; This enables simple and efficient manufacture, assembly and implementation.

The hook 16 can include two elements 162 and 163, hinged on each other and designed so that, when there is no stress, they tend to move away from each other, the element 63 remaining in the extension of the cable 15 and the element 162 moving away from the element 163 so that its end 161 gets engaged with the notch 17. In this “away” position, the two elements 162 and 163 form an angle α1 of 5° to 15°.

This hook 16 can for example be made out of plastic or metal and can be flexible. If necessary, the pull-back means can be planned so that they force the element 162 to take the position illustrated in FIG. 1 and FIG. 2.

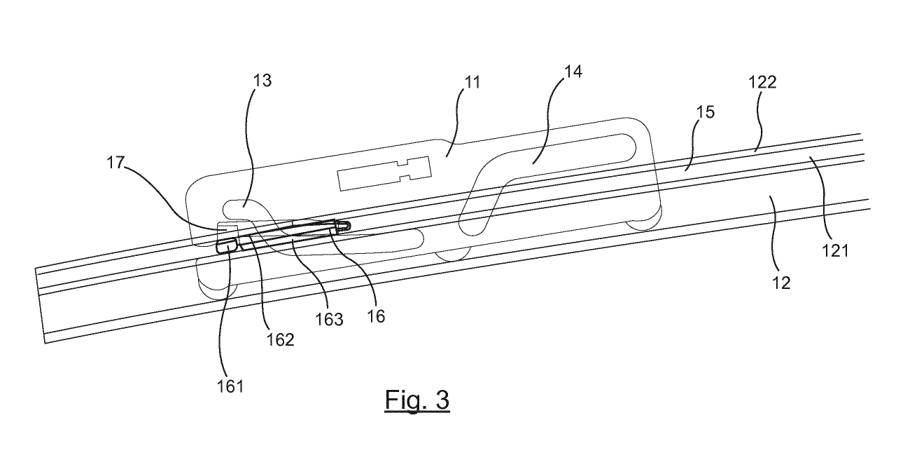

The sheath (more generally the housing for guiding the cable) 121 has an upper wall 122, interrupted on an end portion (corresponding to the first moving area, i.e. the part in which the hook is engaged with the shuttle as illustrated in FIGS. 1 and 2). When the hook 16 reaches the end 1221 of the upper part 122 (FIG. 2), this upper part acts on the element 162 of the hook 16, to bring it gradually towards the element 163 as and when the cable 15 moves towards the right (FIG. 3, which illustrates the beginning of its second moving area, in which the cable is moved while the shuttle remains fixed).

Thus, the element 162 gets placed against the element 163 (they are thus appreciably parallel with each other and therefore with the direction defined by the cable) and its end 161 moves away from the notch (or strike plate) 17. The hook (or bolt) is therefore released from the shuttle 11 which can move relative to the rail 12 while the cable 25 remains immobile in the sheath 121. This is thus a position of detachment or disengagement between the cable and the shuttle.

The element 162 has a concavely curved part 164, enabling efficient control, if necessary, of the movement of this element 162 when it comes into contact with the end 1221.

When the drive cable 15 is moved leftwards, in the figures, and when the hook 16 reaches the end 1221 of the sheath, the hook, because of its flexibility and its shape and/or under the action of the pull-back means, automatically resumes the fixedly attached position, and can get fixedly attached to the shuttle (FIGS. 1 and 2), the end 161 getting engaged with the notch 17.

The motions of the shuttle 11 and the cable 15 are then linked.

### 5.2 Second Embodiment

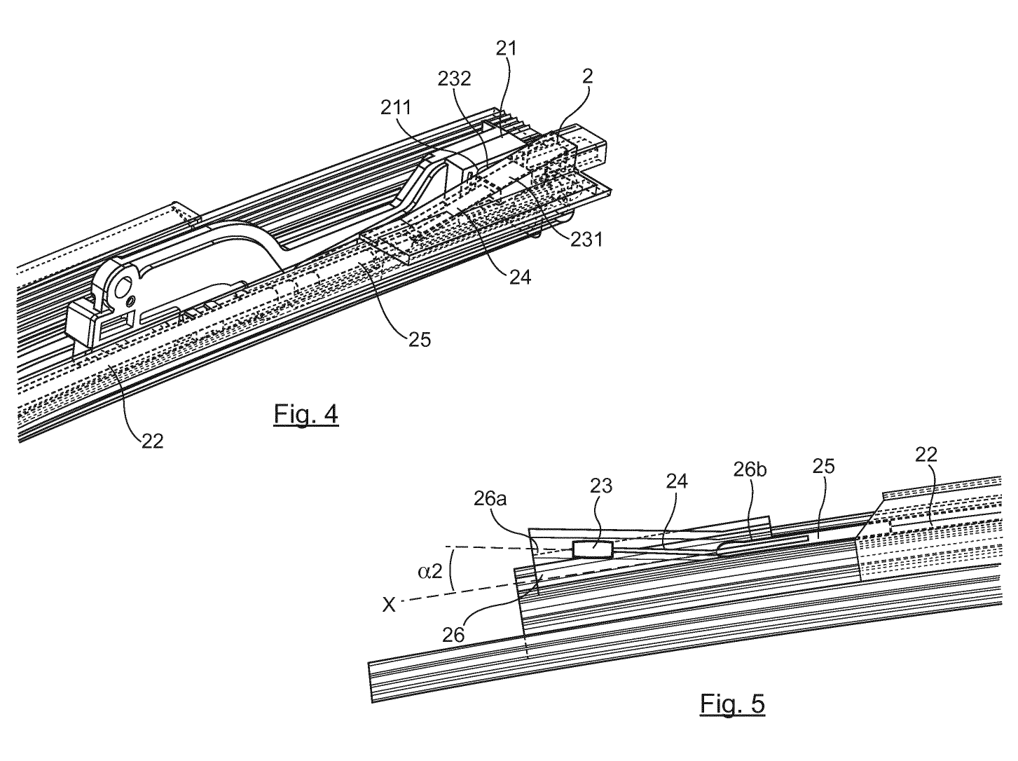

In this second embodiment, illustrated by FIGS. 4 to 8, the fixed attachment element does not take its position, solely because of its flexibility, its shape and/or by the action of the pull-back means. It is guided by a guide portion fixedly attached to the fixed part of the roof (for example fixedly attached to the rail), forming a guide ramp 26 to guide the bolt 23 towards the recess 211 or strike plate (seen in FIG. 4) formed on the shuttle 21 with a cleared area opening into the bottom part of the shuttle.

The cable 22 can have characteristics substantially identical to those of the cable described in the first embodiment.

In this second embodiment, the hooking element has a bolt 23 mounted on a first end of the flexible arm 24. This flexible arm is fixedly attached to the free end of the cable 22. For example, a linking sheath 25 can be over-molded on both the free end of the cable 22 and the second end 24a of the arm 24. The over-molding enables simple and efficient manufacture, assembly and implementation.

The bolt 23 has a contact portion suited to getting fitted into the recess 211 formed in the shuttle, while remaining movable within it. The bolt 23 is for example made out of plastic. In this embodiment, a first portion 231 of the bolt slides on the ramp and a second portion 232 provides the bolt function. This second portion is slightly offset relative to the vertical plane defined by the cable 22 and the arm 24.

FIGS. 4 and 5 illustrate the guide ramp 26 on which or, as the case may be, within which the bolt 23 can slide. This guide ramp 26 has at least one first rectilinear portion 26a, inclined relative to the direction X of the drive cable and, if necessary, a second rectilinear portion 26b parallel to the direction X of the drive cable. The ramp forms for example an angle of 5° to 15° with this direction X. In certain embodiments, a non-rectilinear profile, especially for the first portion, can be planned.

As in the first embodiment, the moving of the cable 22 and the shuttle 21 are linked in a first position, called a fixed attachment position. The position of the connection member and especially of the bolt 23 in this first zone is illustrated in FIGS. 4 and 5.

The movement of the cable 22 (towards the left in FIG. 4, towards the right in FIG. 5) corresponds to a translation of the bolt 23 in a similar direction and vice versa. Since the bolt 23 is engaged with the shuttle 21 by means of the recess 211, the moving moving of the cable 22 provides for the moving of the shuttle 21 (and therefore of the movable part of the roof) relative to the fixed part of the roof.

As and when the bolt approaches the second ramp portion 26b, it moves into the interior of the recess 211 (downwards) of the shuttle 21. When the bolt 23 reaches the second ramp portion 26b, the operation is in a second position, called a detachment position. The bolt 23 is taken out of the recess 211 and the motion of the shuttle 21 is dissociated from the motion of the bolt 23 and therefore from the cable 22 which stops.

The arm 24 of the connection member has the function of flexibly linking the bolt 23 and the cable 22 by means of the sheath 25. Thus, it is preferably made out of a flexible and supple material, for example in the form of a steel strip, capable of passing from the position of fixed attachment, in forming an angle α2 relative to the direction X defined by the cable (in the vicinity of the strip if the cable follows a curved movement), in which it extends in the extension of the cable. It can also be essentially rigid and hinged relative to the sheath 25.

When the drive cable 22 is moved rightwards in FIG. 4, (towards the left in FIG. 5) and when the bolt 23 reaches the guide ramp, it slides in the reverse sense in the second portion 26b until it reaches the first portion 26a and returns to a fixed attachment position. The shuttle 21 and the cable 22 are again linked or fixedly attached.

FIGS. 4 to 6 illustrate one embodiment of a connection member comprising an arm 24 formed like a strip, the end 24 of which carries the bolt 23 enabling the fixed attachment. The bolt 23 is for example over-molded on the end 24a of the arm.

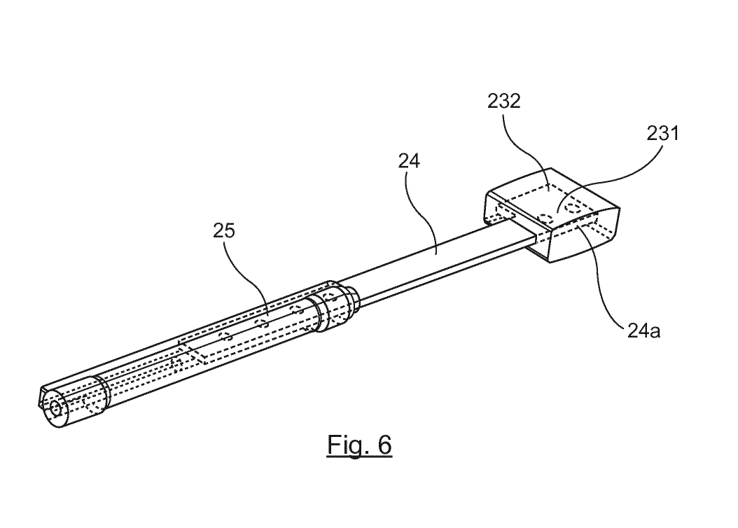

FIGS. 6 to 8 all show the connection member in the configuration that it adopts in the detached position.

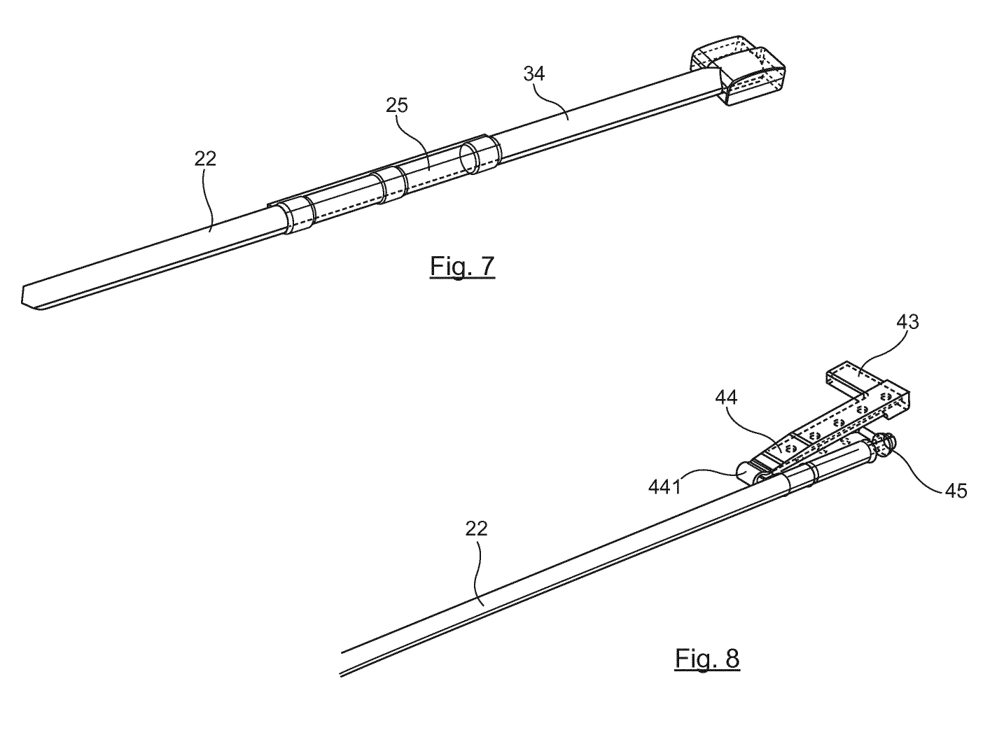

FIGS. 7 and 8 show two alternative embodiments of the connection member and therefore of the bolt 23 and the arm 24.

In a first variant (FIG. 7) the arm 34 is formed by a flexible rod and/or hinged on the cable 22, with a diameter substantially equal to the diameter of the cable 22 or formed by the end part of this cable 22.

According to a second variant (FIG. 8), the arm 44 is constituted by a strip offset relative to the direction X of the sheath 25. The arm is linked to the sheath by a linking part 441, forming a pivot link between the two elements. The arm 44, at its free end, carries the bolt 43 (extending in this embodiment perpendicularly to the arm), that is to cooperate with the recess 211 of the shuttle 21. In this embodiment, the bolt 43 is over-molded on the arm.

1. Glazed roof for a motor vehicle comprising a fixed part in which an aperture is made and a panel that is movable relative to the fixed part, capable of closing off said aperture in a closing-off position,
the moving of said movable panel implementing two shuttles guided in translation respectively in two rails, means for fixed attachment/detachment making it possible to link or not link the movement of each of said shuttle with the movement of a driving cable,
wherein said means of fixed attachment/detachment comprise a hooking element movable between two positions:
a position of fixed attachment in which it forms an angle of 5° to 15° with the direction of said driving cable, an end portion of said hooking element cooperating with a complementary housing in said shuttle; and
a detached position in which it extends appreciably in parallel to the direction of said driving cable, said end portion being moved out of said housing.

2. Glazed roof according to claim 1, wherein said hooking element comprises a hook over-molded on the free end of said driving cable.

3. Glazed roof according to claim 2, wherein said hook is shaped so as to be brought back into said deployed position and/or fitted out with pull-back means tending to bring it back into said deployed position.

4. Glazed roof according to claim 1, wherein said cable circulates in a sheath or a guide housing fixedly attached to said rail.

5. Glazed roof according to claim 4, wherein said sheath or said housing has a portion that is open in said first moving area and a portion that is closed in said second moving area, constraining said hook to take said folded position.

6. Glazed roof according to claim 5, wherein said hook has a contact area cooperating with the end of said sheath or said housing to control the movement of said hook between the two positions.

7. Glazed roof according to claim 2, wherein said hook has two hinged elements, a first movable element to ensure fixed attachment with the shuttle and a second element remaining in the extension of said cable.

8. Glazed roof according to claim 7, wherein said first element carries a locking pin cooperating with a notch formed in the shuttle.

9. Glazed roof according to claim 1, wherein said hooking element has a bolt mounted in the extension of said cable and guided between said fixed attachment position and said detachment position by a guiding ramp fixedly attached to said fixed part.

10. Glazed roof according to claim 9, wherein said bolt is over-molded on the end of said cable and on an arm that is movable relative to said cable and mounted in its extension.

11. Glazed roof according to claim 9, wherein said bolt cooperates with a recess formed in said shuttle element.

12. Glazed roof according to claim 10, wherein a linking sheath fixedly attaches the free end of the cable and one end of the arm.

13. Glazed roof according to claim 10, wherein said arm is made out of a flexible material.

14. Glazed roof according to claim 10, wherein said arm comprises a strip that is hinged relative to said cable.

15. Glazed roof according to claim 10, wherein said arm is mounted so as to be rotationally movable relative to the linking part fixedly attached to said cable and/or a sheath that bears it.
